(19) United States
(12) Patent Application Publication
(10) Pub. No.: US 2026/0100573 A1
(43) Pub. Date: Apr. 9, 2026

(54) DRIVER CIRCUIT WITH REAL-TIME THERMAL MANAGEMENT

(71) Applicant: Infineon Technologies AG, Neubiberg (DE)

(72) Inventors: Mirko BERNARDONI, Villach (AT); Christian DJELASSI-TSCHECK, Villach (AT); Robert ILLING, Finkenstein am Faaker See (AT); Ioan-Alexandru TRANCA, Villach (AT)

(21) Appl. No.: 19/351,809

(22) Filed: Oct. 7, 2025

(30) Foreign Application Priority Data
Oct. 8, 2024 (DE) 102024128959.7

(51) Int. Cl. H02H 5/04

(52) U.S. Cl. CPC H02H 5/047

(57) ABSTRACT

An electronic circuit for driving an electronic switch is described herein. In one embodiment, the electronic circuit includes a driver circuit configured to provide a drive signal for the electronic switch in accordance with a control signal, and a multiplier configured to receive, as input signals, a current sense signal representing a current flowing through a load current path of the electronic switch and a voltage sense signal representing a voltage drop across the load current path of the electronic switch. The electronic circuit further includes an estimator circuit configured to receive a multiplier output signal from the multiplier and to generate, based on the multiplier output signal, a temperature signal representing an estimated temperature of the electronic switch. Furthermore, the electronic circuit includes a control circuit configured to receive the temperature signal and to generate, based on the temperature signal, the control signal for the driver circuit.

### TECHNICAL FIELD

This invention relates to the field of driver circuits for driving electronic switches such as metal-oxide-semiconductor field-effect transistors (MOSFETs).

### BACKGROUND

When designing electric systems, a mandatory requirement is to guarantee that the semiconductor switches used in the system are operated only within their Safe Operating Area (SOA). For semiconductor switches, the SOA is usually defined by three parameters. First, a maximum load current must not be exceeded. Second, a maximum voltage (for MOSFETs for example the Drain-Source-Voltage) must not be exceeded and, third, a maximum junction temperature of the semiconductor switch must not be exceeded. While the load current and the voltage are parameters which usually can be easily assessed by measurement, the junction temperature cannot be assessed without the provision of temperature sensors. In case of integrated systems, temperature sensors may be available and may be part of the integrated circuit. However, when a system includes several different semiconductor devices (i.e. when the driver circuit and the semiconductor switch are not part of the same integrated circuit), assessing the junction temperature of the semiconductor switch may be challenging, and providing an external temperature sensor may increase the system complexity and costs.

An additional temperature sensor with potentially additional signal conditioning blocks (filter, biasing, etc.) may lead to a more expensive system. The temperature sensor can only be placed on the circuit board (PCB), which cannot be used to detect fast transient temperature peaks (e.g. 100 μs or 1 ms) in the active area of the semiconductor switch.

Additionally, the provision of a temperature sensor might interfere with the layout of the PCB and the PCB traces have to be routed differently, thereby further increasing the overall system complexity.

There is a need for driver circuits that are capable of providing an over-temperature protection for an external electronic switch without relying on a temperature sensor in order to ensure that the semiconductor switch is operated within the its SOA. Further, an application specific configurability of the over-temperature protection function may be desired.

### SUMMARY

An electronic circuit for driving an electronic switch is described herein. In one embodiment, the electronic circuit includes a driver circuit configured to provide a drive signal for the electronic switch in accordance with a control signal, and a multiplier configured to receive, as input signals, a current sense signal representing a current flowing through a load current path of the electronic switch and a voltage sense signal representing a voltage drop across the load current path of the electronic switch. The electronic circuit further includes an estimator circuit configured to receive a multiplier output signal from the multiplier and to generate, based on the multiplier output signal, a temperature signal representing an estimated temperature of the electronic switch. Furthermore, the electronic circuit includes a control circuit configured to receive the temperature signal and to generate, based on the temperature signal, the control signal for the driver circuit. A further embodiment relates to a system which includes the above-mentioned electronic circuit and the electronic switch.

### BRIEF DESCRIPTION OF THE DRAWINGS

The embodiments described herein can be better understood with reference to the following description and drawings. The components in the figures are not necessarily to scale, emphasis instead being placed upon illustrating the principles of the embodiments. Furthermore, in the figures, like reference numerals designate corresponding parts. In the drawings:

FIG. 1 illustrates the basic structure of a system including an electronic circuit (e.g. a driver IC) for driving an electronic switch such as a power MOSFET.

FIG. 2 illustrates one embodiment of an electronic circuit with a gate driver and an estimator that is capable of estimating the temperature of an external switch.

FIG. 3 illustrates the embodiment FIG. 2 in more detail.

FIG. 4 illustrates the one exemplary implementation of the estimator circuit.

FIG. 5 illustrates a modification of the example of FIG. 2.

FIG. 6 illustrates the example of FIG. 5 in more detail.

FIG. 7 illustrates one exemplary implementation of the estimator circuit with a filter bank composed of three first order low pass filters.

FIG. 8 is a diagram illustrating that the behavior of the estimator can be adapted to a given curve that represents a specific thermal behavior of the external electronic switch.

FIG. 9 illustrates the toggling of the external electronic switch during a switch-on period of a capacitive load.

### DETAILED DESCRIPTION

So-called “smart switches” are integrated circuits (ICs) which include, in a single semiconductor die, one or more electronic switches (e.g. a power MOS transistor), corresponding driver circuits (e.g. a gate driver) and supplemental circuitry, which may provide, e.g., over-temperature and over-current protection functions. Such a single-chip approach usually allows the use of temperature sensors that may be integrated within (or very close to) the transistor cell array that forms the power transistor. In integrated circuits, pn-junctions are usually used as temperature sensors.

However, in some applications integrated driver circuits (driver ICs) are used for driving discrete electronic switches such as power MOSFETs, which usually do not have integrated temperature sensors. Although discrete power transistors with integrated temperature sensors exist, the use of such devices may be undesirable because the temperature sensor signal has to be preprocessed by some signal conditioning circuitry and then routed to the driver IC via the PCB which increases the complexity of the system design and the overall costs. The embodiments described herein allow for a temperature protection feature in the driver IC without requiring a temperature sensor for directly measuring temperature information.

If the temperature of a circuit component is to be assessed without direct or indirect measurement of the temperature, emulating the thermal behavior of the circuit component may be considered. In the case of wires for example, its thermal behavior can be estimated from the load current. The resistance of a wire does not significantly change during operation and, therefore, the knowledge of the load current i_{L} and the wire's resistance R is sufficient to estimate the power dissipation in the wire, wherein the dissipated power P is proportional to the square of the load current i_{L} (P=R·i_{L}²). The same concept can be used to determine the temperature of other passive resistive components, such as connectors or conductive traces of PCBs.

However, active components, such as semiconductor switches, experience considerable changes in their output resistance depending on their operation mode (linear mode, saturation mode, switching, clamping, etc.) and therefore (different from a simple wire) R cannot be regarded as a constant parameter.

FIG. 1 illustrates the basic structure of a system including an electronic circuit 10 (e.g. a driver IC) for driving a power MOSFET 40. In this context, “driving a power MOSFET” means providing a gate voltage/current to switch the power MOSFET on and off. It is understood that the concepts described herein are not limited to MOSFETs. Any other type of electronic switch such as bipolar junction transistors (BJTs), insulated gate bipolar transistors (IGBTs) junction field-effect transistors (JEFTs) may also be used. For some types of electronic switches the control electrode is not referred to as “gate” (e.g. the control electrode of a BJT is called base). However, using the terms gate voltage or gate current in the following discussion should not be interpreted in a way that the respective embodiment is limited to transistors that actually have a gate electrode. As mentioned the concepts described herein may readily applied to other types of electronic switches (e.g. BJTs which require a base current instead of a gate voltage).

The circuit of FIG. 1 includes a current sense circuit which may be a simple current sense resistor connected in series to the load current path of the electronic switch 40. In the present example, the current sense resistor RCS (shunt resistor) is connected between the source electrode of the MOSFET 40 and the load Z. The voltage drop V_{CS} across the current sense resistor R_{CS} can be used as a current sense signal, which is labelled S_{CS} in FIG. 1. The equation V_{CS}=i_{L}·R_{CS} applies, wherein i_{L} denotes the load current passing through the MOSFET 40. In equations and formulas, R_{CS} represents the current sense resistor's resistance.

The MOSFET 40 is connected in a high-side configuration, in which the load Z is coupled between the MOSFET 40 and ground potential (or any other constant reference potential). In this case, the drain electrode of the MOSFET 40 is connected to a voltage supply which provides the supply voltage V_{B} (e.g. the battery voltage of an on-board battery in automotive applications).

The electronic circuit 10 is configured to output a drive signal S_{ON}′ (e.g. a gate voltage V_{G}) to switch the MOSFET 40 on and off. During normal operation, the drive signal S_{ON}′ may be generated in accordance with a switching command, which the electronic circuit may receive via a communication link. In the present example, the electronic circuit includes a Serial Peripheral Interface (SPI) which allows to receive digital information (e.g. data and commands) from an external controller, which is the microcontroller 20 in the present example. It is understood that the SPI bus is merely an illustrative example that may be replaced by other communication links (i.e. physical connections and communication protocols). In some examples, the electronic circuit 10 includes an input pin for receiving a logic signal. In this example, transitions from a Low level to a High level of the logic signal (or vice versa) may be considered as switching commands for switching the electronic switch on (or off).

The electronic circuit 10 also receives the current sense signal S_{CS} and also a voltage sense signal S_{VS}, which represents the voltage drop V_{DS} (drain-source voltage) across the load current path of the MOSFET 40. The electronic circuit 10 may process the current sense signal S_{CS} to implement an over-current protection function which causes a switch-off of the electronic circuit 40 in the event of an over-current or short circuit. When using n-channel MOSFETS in a High side configuration, the electronic circuit 10 needs to receive the supply voltage V_{B} and the source voltage V_{S} in order to be able to provide (e.g. using a charge pump) a gate voltage V_{G} which may be higher than the supply voltage V_{B}.

In the present example, a supply circuit 30 provides a supply current V_{DD} for the electronic circuit 10 and the microcontroller 20. The supply circuit 30 may include a voltage regulator and generate the supply voltage V_{DD} from the (higher) supply voltage V_{S}. While the supply voltage V_{DD} may be, for example, between 2.5 and 5 volts, the supply voltage V_{B} may be 12 volts more.

The microcontroller 20 may be configured to digitally communicate with the electronic circuit 10. In the present example, the microcontroller 20 and the electronic circuit 10 are equipped with a Serial Peripheral Interface (SPI). The SPIs are connected via bus lines to exchange serial data. Moreover, the microcontroller 20 may have a Controller Area Network (CAN) interface to communicate with a superordinate system controller. It is understood that any other communication links and protocols may be used instead of CAN or SPI.

As mentioned, the electronic circuit 10 serves as a driver IC for driving the power transistor 40 in order to switch it on an off. The electronic circuit 10 may be configured to switch the power transistor 40 on and off in accordance with switching commands received via the SPI bus from the microcontroller 20. In addition thereto, the electronic circuit 20 may provide protective functions such as an overcurrent shut-down or a current limitation, an undervoltage detection or the like. An overtemperature protection, which is a common feature for smart switches, which include the power transistor and the control/driver circuitry in a single semiconductor die, a temperature information that represents the temperature of the power transistor is not available in the electronic circuit 10 because the power transistor 40 is a discrete transistor integrated in a separate semiconductor die.

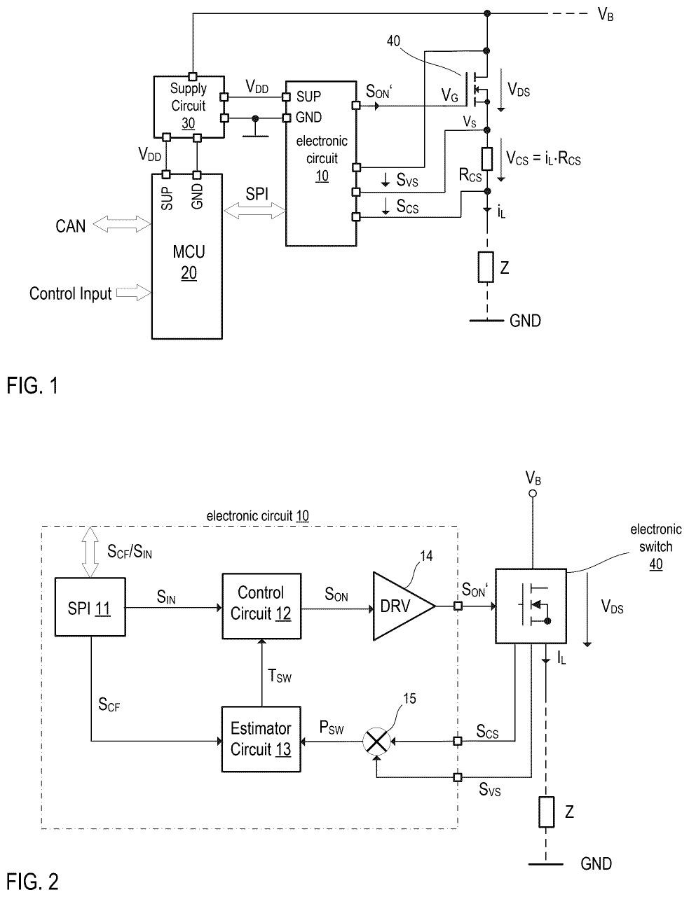

FIG. 2 illustrates one embodiment of an electronic circuit which allows an over-temperature protection for the external semiconductor switch 40 without receiving any temperature information. The circuit of FIG. 2 basically includes the same components as the circuit of FIG. 1, wherein the electronic circuit 10 is shown in more detail. Accordingly, the electronic circuit 10 includes a driver circuit 14 that is configured to provide a drive signal S_{ON}′ (e.g. a gate voltage V_{G} or a gate current i_{G}) for the power transistor 40 in accordance with a control signal S_{ON}, which is a logic signal that can assume a Low level and a High level. When MOS transistors are used such driver circuits are commonly referred to as gate drivers.

As already explained with reference to FIG. 1, the electronic circuit 10 receives a current sense signal S_{CS} (representing the load current i_{L} passing through the power transistor 40) and a voltage sense signal S_{VS} (representing voltage drop V_{DS} across the load current path of the power transistor 40). According to the embodiments discussed herein the electronic circuit includes a multiplier 15 that receives the current sense signal S_{CS} and the voltage sense signal S_{VS} as input signals. The output signal of the multiplier 15 represents a power P, wherein P=i_{L}·V_{DS} in the present example. The product i_{L}·V_{DS} represents the power dissipated in the power transistor 40.

The multiplier output signal (power signal P_{SW}) itself does not indicate a temperature. However, it may be used as an input to a thermal model of the power transistor. In the present example, the electronic circuit 10 includes an estimator circuit 13 that receives the multiplier output signal P_{SW} from the multiplier 15 and generates a temperature signal T_{SW} that represents an estimated temperature of the power transistor 40. The estimator circuit is configured to determine (estimate) the temperature T_{SW} based on the power signal P_{SW}. Furthermore, the electronic circuit 10 includes a control circuit 12 that is configured to receive the temperature signal T_{SW} and to generate the control signal S_{ON} for the driver circuit 14 based on the temperature signal T_{SW}. That is, the control signal S_{ON} depends on the estimated temperature.

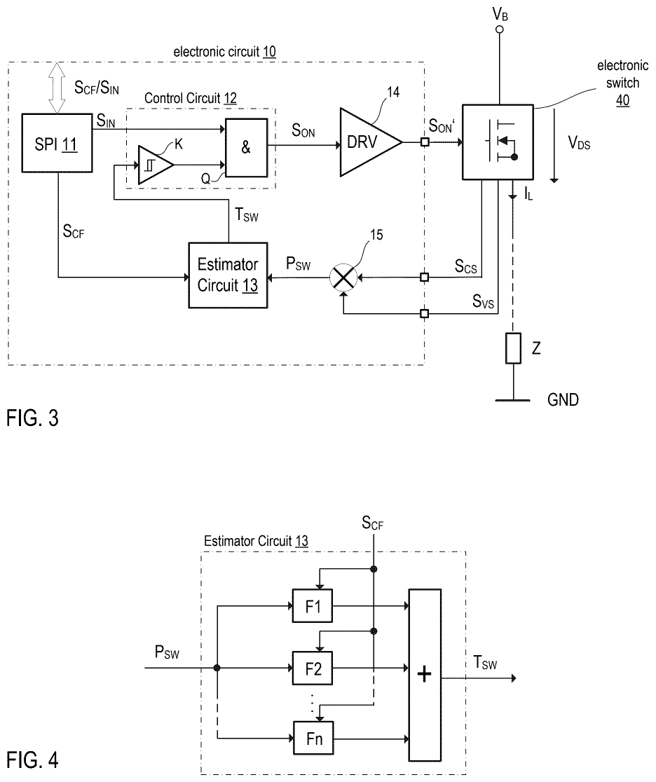

For example, the control circuit 12 may be configured to output the control signal S_{ON} with a first level (e.g. a Low level) that causes the driver circuit 14 to switch off the electronic switch 40 when the temperature signal T_{SW} exceeds a first threshold. Conversely, the control circuit 12 may be configured to output the control signal S_{ON} with a second level (e.g. a High level) that causes the driver circuit 14 to switch on the electronic switch 40 when the temperature signal T_{SW} falls below a second threshold. The first and second thresholds may be configurable and be set in response to the reception of configuration data S_{CF} (via the SPI interface 11). The example of FIG. 3 illustrates this function.

The circuit of FIG. 3 is the same like in FIG. 1 except that the one simplified embodiment of the control circuit of FIG. 12 is shown in more detail. Accordingly, the control circuit 12 receives an input signal S_{IN}. The input signal S_{IN} may be a logic signal that indicates (by its logic level) the desired switching state of the power transistor 40. Accordingly, when S_{IN} has a High Level, the control circuit 12 may signal the gate driver 14 to switch the power transistor 40 on. Conversely, when S_{IN} has a Low Level, the control circuit 12 may signal the gate driver 14 to switch the power transistor 40 off. The input signal S_{IN} may be received via a dedicated chip pin or (as shown in FIG. 3) be generated by the communication interface 11 in accordance with a switching command received via the communication link (e.g. the SPI bus).

The input signal S_{IN} may be overridden by when the estimated temperature T_{SW} provided by the estimator circuit 13 indicates a too high temperature. The above-mentioned first and second thresholds may be implemented using a comparator with hysteresis. According to FIG. 3, the control circuit 12 includes a comparator K which has a hysteresis defined by the first and second thresholds. The output of the comparator K and the input Signal S_{IN} are provided to the inputs of an and-gate Q. As long as the temperature T_{SW} is below the first threshold, the comparator K outputs a High level and, therefore, the and-gate Q is transparent, i.e. it forwards the logic level of the input signal S_{IN} to the gate driver 14, which charges the gate of the power transistor 40 to switch it on (and to keep it an on state). When the temperature T_{SW} exceeds the first threshold, the comparator K outputs a Low level and, therefore, the and-gate Q is not transparent anymore and blanks the input signal S_{IN}. As a result, the and-gate Q outputs a Low level to the gate driver 14, which discharges the gate of the power transistor 40 to switch it off (and to keep it in an off state). The output of the comparator K will remain at a Low level (therefore blanking the input signal with the help of the and-gate) until the estimated temperature T_{SW} falls below the second threshold, which is lower than the first threshold.

As discussed above, the estimator circuit 13 receives the multiplier output signal P_{SW} (power signal) from the multiplier 15 and generates—using a thermal model of the power transistor 40—a temperature signal T_{SW} that represents an estimated temperature of the power transistor 40. The thermal model may be realized, for example, by a filter bank as shown in FIG. 4.

According to the example shown in FIG. 4 the estimator circuit 13 may include a filter bank that is composed of a plurality of filters F1, F2, . . . , Fn. Each of the n filters may be a first order filter, for example a first order low-pass filter. The filters F1, F2, . . . , Fn receive the power signal P_{SW} as input signal, wherein the output signals of the filters F1, F2, . . . , Fn are summed up by an adder. The resulting sum signal T_{SW} generated by the adder can be interpreted as an estimated temperature of the electronic switch.

In one example, (at least) three first order filters are used (n=3). Accordingly, each filter F1, F2, F3 has a gain and a time constant. In this example, the estimator's behavior is determined by six parameters (three gains and three time constants). These parameters are configurable, and may be set in accordance with configuration parameters S_{CF} that are received from an external controller, e.g. via the SPI interface 11, and stored in a memory. In one example, the configuration parameters S_{CF} are stored in a non-volatile memory (see e.g. FIG. 6). The memory may be considered part of the communication interface or a separate subsystem of the circuit 10.

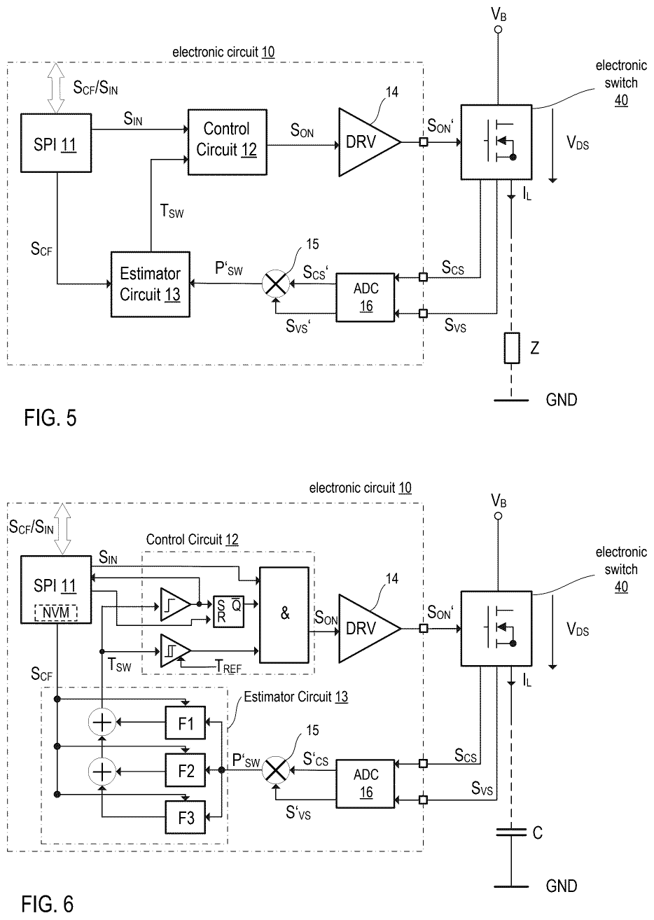

In the example of FIG. 3, the multiplier 15 is an analog multiplier and the estimator circuit 13 includes analog filters. However, the electronic circuit 10 may include an analog-to-digital converter (ADC) circuit 16 as shown in the example of FIG. 5. According to FIG. 5 the ADC circuit 16 receives the signals S_{VS} and S_{CS} and generates respective digital signals S_{VS}′ and S_{CS}′. Using the ADC circuit 16 allows a digital implementation of the multiplier 15 and the estimator circuit 13. Therefore, the multiplier 15 and the estimator circuit 13 are digital circuits in the example of FIG. 5, i.e. these circuits may be implemented using a memory and processor that is configured to execute firmware instructions stored in the memory to perform the described function (multiplication and filtering). Additionally or alternatively, hard-wired arithmetic and logic circuits may be used. The ADC circuit 16 may include more ADCs operating in parallel. Alternatively, the ADC circuit 16 may include a multiplexer, which allows the conversion of two (or more) analog signals with a single ADC. Furthermore, the ADC circuit 16 may include a sample and hold (S&H) circuit.

FIG. 6 illustrates a further example, which is essentially the same as in FIG. 5, wherein the estimator circuit 12 and control circuit 12 are shown in more details. Accordingly, the control circuit 12 may include a comparator with hysteresis as discussed above with reference to FIG. 3. Also shown in FIG. 6 is a reference temperature T_{REF} signal received by the comparator with hysteresis. The hysteresis may depend on the reference temperature signal. In addition thereto, the control circuit 12 may include a second comparator without hysteresis that is configured to blank the input signal S_{IN} as soon as the temperature T_{SW} reaches a third threshold. In the present example, the output signal of the second comparator is latched (stored) by a flip-flop. Therefore, as soon as the temperature T_{SW} reaches the third threshold (which may be higher than the second threshold), the input signal S_{IN} is blanked and remains blanked until the flip-flop is reset. The reset signal for the flip-flop may be for example, provided by the SPI interface 11 in response to a reset command received via the SPI bus.

The estimator 13 is composed of three filter digital filters F1, F2, F3, which receive the same digital input signal P_{SW}′ (output of the digital multiplier 15). The outputs of the three filters F1, F2, F3 is summed up and the sum signal T_{SW} is output to the comparator with hysteresis mentioned above. Each filter may be a first order filter, in particular a first order low-pass filter. In one example, each filter may be an IIR (Infinite Impulse Response) filter, which can be represented by a gain and a time constant.

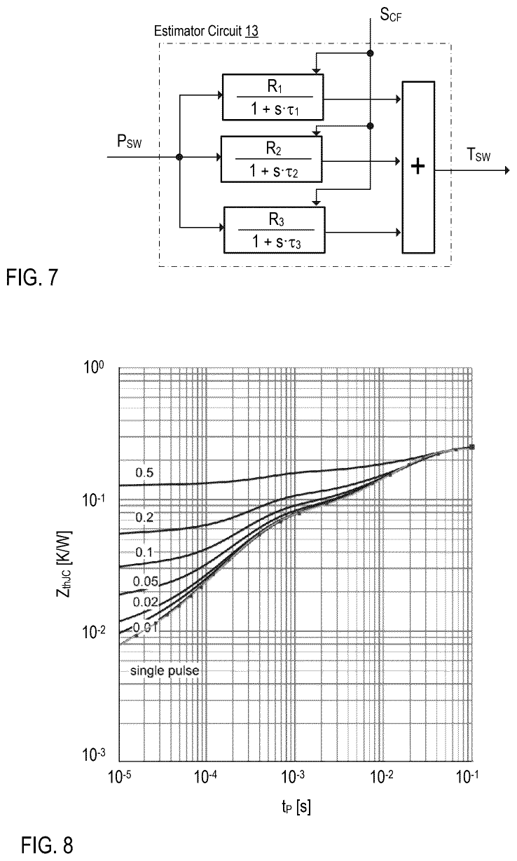

The example of FIG. 7 illustrates the transfer functions (in the form of Laplace transforms of the impulse responses) of the three filters F1, F2, and F3 in the analog domain. The parameters R₁, R₂, and R₃ are the filter gains, and the parameters t₁, t₂ and t₃ are the filter time constants. The variable s is the complex frequency parameter. As mentioned, these parameters may be configurable (parameter set S_{CF}). In a digital implementation the Laplace transform may be replaced by a z-Transform, which may have the form a₁/(1−b₁·z⁻¹), wherein a₁ and b₁ are parameters that represent (depend on) the gain R₁ and the time constant t₁ of the filter.

By selecting suitable filter parameters, the estimator circuit 12 may be adapted to the thermal behavior of a specific power transistor. FIG. 8 is a diagram taken from the data sheet of a power MOSFET. It illustrates (inter alia) the resulting temperature per Watt (K/W) over the time of a pulse. The bottom line represents the relation between temperature (normalized with respect to the input power) of the MOSFET dependent and pulse length. The dots are estimated valued generated by the estimator circuit 12 (with an appropriate parameter set). It can be seen that the estimated temperature values match the actual thermal behavior of the MOSFET (represented by the diagram in the data sheet).

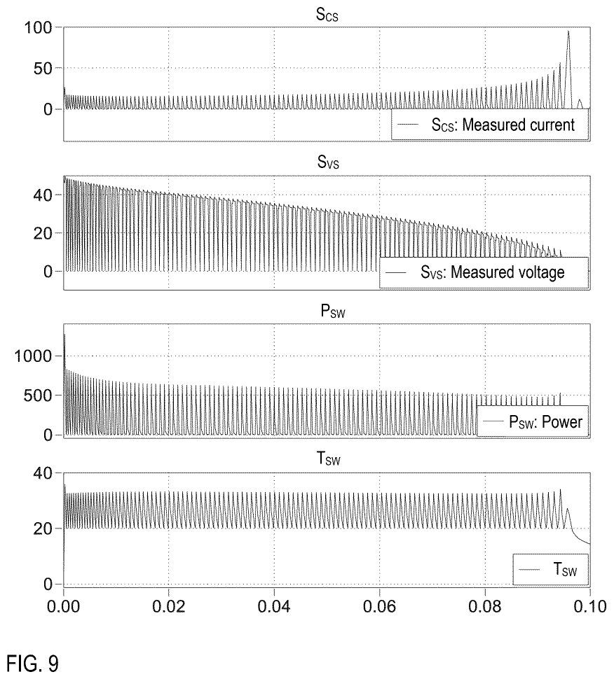

FIG. 9 illustrates the toggling of the power transistor 40 during a switch-on period when a capacitive load is connected to the power transistor 40. The fourth (bottom) diagram of FIG. 9 illustrates the estimated temperature varying between approximately 20 K (second threshold) and 35 K (first threshold). The first (top) and the second diagram of FIG. 9 illustrate the oscillating load current (current sense signal S_{CS}) and the oscillating voltage (voltage sense signal S_{VS}), respectively. As explained above, the oscillation is due to the fact, that the control circuit 12 causes a switch-off of the power transistor 40 when the estimated temperature reaches the first threshold and a switch on only when the estimated temperature has fallen to the second threshold. The third diagram illustrates the multiplier output (power signal P_{SW}).

It can be seen that, as the capacitive load C (see FIG. 6) is gradually charged (stepwise in each cycle) the voltage across the power transistor (as represented by S_{VS}) decreases as the voltage across the capacitive load increases. As a consequence the load current (as represented by S_{CS}) gradually increases.

Finally, it is noted that the electronic circuit 10 may be configured to drive/control more than one MOSFETs (or other electronic switches). In this case, the electronic circuit 10 is said to have multiple channels. In such a multi-channel embodiment, a gate driver 14, a multiplier 15 and estimator circuit 13 may be provided for each channel. The communication interface 11 and the control circuit 12 may be configured to cooperate with the components of all channels

Below examples of the present disclosure are summarized. It is understood that the following is not an exhaustive enumeration but rather an exemplary summary. Technical features of the examples may be combined to create further examples.

Example 1: An electronic circuit 10 comprising: a driver circuit 14 configured to provide a drive signal S_{ON}′ for an electronic switch 40 in accordance with a control signal S_{ON}; a multiplier 15 configured to receive—as input signals—a current sense signal S_{CS} representing a load current i_{L} passing through a load current path of the electronic switch 40 and a voltage sense signal S_{VS} representing a voltage drop V_{DS} across the load current path; an estimator circuit 13 configured to receive a multiplier output signal P_{SW} (power signal) from the multiplier 15 and to generate—based on the multiplier output signal P_{SW}—a temperature signal T_{SW} representing an estimated temperature of the electronic switch 40; and a control circuit 12 configured to receive the temperature signal T_{SW} and to generate—based on the temperature signal T_{SW}—the control signal S_{ON} for the driver circuit 14.

Example 2: The electronic circuit of claim 1, wherein the control circuit 12 is configured to output the control signal S_{ON} with a first level (e.g. Low level) that causes the driver circuit 14 to switch off the electronic switch 40 when the temperature signal T_{SW} exceeds a first threshold.

Example 3: The electronic circuit of claim 1 or 2, wherein the control circuit 12 is configured to output the control signal S_{ON} with a second level (e.g. High level) that causes the driver circuit 14 to switch on the electronic switch 40 when the temperature signal T_{SW} falls below a second threshold. The first and the second threshold determine a hysteresis.

Example 4. The electronic circuit of any of claims 1 to 3, wherein the control circuit 12 is configured to output the control signal S_{ON} with the first level that causes the driver circuit 14 to switch off the electronic switch 40 when the temperature signal T_{SW} exceeds a third threshold and to keep the electronic switch 40 in an off state until a reset (see, e.g. RS flip flop of FIG. 6).

Example 5: The electronic circuit of claim 2 or 3, wherein each, the first threshold and the second threshold, represents a respective temperature differences between a junction temperature of an active area of the electronic switch 40 and a chip temperature remote from the active area.

Example 6: The electronic circuit of any of the claims 1 to 5, wherein the estimator circuit 13 includes a low-pass filter, wherein the temperature signal T_{SW} represents the low-pass filtered multiplier output signal P_{SW}.

Example 7: The electronic circuit of any of claims 1 to 5, wherein the estimator circuit 13 emulates a thermal response of the electronic switch 40 using the multiplier output signal P_{SW} as input.

Example 8: The electronic circuit of claim 6, wherein the estimator circuit 13 is configured to receive one or more (configuration) parameters S_{CF} representing at least one filter parameter, such as filter gain and filter time constant.

Example 9: The electronic circuit of one of the claims 1 to 8, wherein the electronic circuit 10 further comprises: an analog-to-digital converter circuit 16 configured to convert the current sense signal S_{CS} and the voltage sense signal S_{VS} into a digital current sense signal S_{CS}′ and a digital voltage sense signal S_{VS}′, respectively, and wherein the multiplier 15 is configured to multiply the digital current sense signal S_{CS}′ and digital voltage sense signal S_{VS}′.

Example 11: The electronic circuit of one of the claims 1 to 10, wherein the control circuit 12 comprises a first comparator configured to receive the temperature signal T_{SW}.

Example 12: The electronic circuit of claim 10, wherein the first comparator has a hysteresis (which determines e.g. the mentioned first and second thresholds).

Example; 13: The electronic circuit of one of the claims 1 to 10, wherein the control circuit 12 comprises a first comparator configured to receive the temperature signal T_{SW} and a reference signal representing a temperature threshold (from which, in one example, the first and second thresholds may be derived).

Example 14: The electronic circuit of claim 11, wherein the control circuit 12 further comprises a logic circuit configured to receive an output signal of the first comparator and an input signal (S_{IN}) of the electronic circuit, and wherein the logic circuit outputs the control signal S_{ON} for the driver circuit 14.

Example 15: The electronic circuit of one of the claims 1 to 14, wherein the electronic circuit 10 further comprises a communication interface 11 coupled to the control circuit 12, wherein the control circuit 12 is configured to receive, via the communication interface 11, information from an external controller 20 via the communication interface 11.

Example 16: The electronic circuit of claim 15, wherein the communication interface 11 is coupled to the estimator circuit 13, wherein the estimator circuit 13 is configured to receive—via the communication interface 11—information from the external controller 20 via the communication interface 11.

Example 17: The electronic circuit of claim 15 or 16, wherein the information received by the estimator circuit 13 from the communication interface 11 is stored in a non-volatile memory.

Example 18: The electronic circuit of claim 15 when referring to claim 8, wherein the communication interface 11 is configured to receive data representing the at least one filter parameter S_{CF} from the external controller.

Example 19: The electronic circuit of any of claims 1 to 17 further comprising: at least one first chip contact configured to receive the current sense signal S_{CS} and at least one second chip contact configured to receive the voltage sense signal S_{VS}.

Example 20: A system comprising; an electronic switch 40 integrated in a first semiconductor die; an electronic circuit 10 integrated in a second semiconductor die, wherein the electronic circuit 10 comprises: a driver circuit 14 configured to provide a drive signal S_{ON}′ to the electronic switch 40 in accordance with a control signal S_{ON}; a multiplier 15 configured to receive, as input signals, a current sense signal S_{CS} representing a load current i_{L} passing through a load current path of the electronic switch 40 and a voltage sense signal S_{VS} representing a voltage drop V_{DS} across the load current path; an estimator circuit 13 configured to receive a multiplier output signal P_{SW} from the multiplier 15 and to generate, based on the multiplier output signal P_{SW}, a temperature signal T_{SW} representing an estimated temperature of the electronic switch 40; a control circuit 12 configured to receive the temperature signal T_{SW} and to generate—based on the temperature signal T_{SW}—the control signal S_{ON} for the driver circuit 14.

Example 21: The system of claim 20, wherein the first semiconductor die and the second semiconductor die are integrated in one chip package.

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

1. An electronic circuit (10) comprising:
a driver circuit (14) configured to provide a drive signal (S_{ON}′) for an electronic switch (40) in accordance with a control signal (S_{ON});
a multiplier (15) configured to receive, as input signals, a current sense signal (S_{CS}) representing a load current (i_{L}) passing through a load current path of the electronic switch (40) and a voltage sense signal (S_{VS}) representing a voltage drop (V_{DS}) across the load current path;
an estimator circuit (13) configured to receive a multiplier output signal (P_{SW}) from the multiplier (15) and to generate, based on the multiplier output signal (P_{SW}), a temperature signal (T_{SW}) representing an estimated temperature of the electronic switch (40);
a control circuit (12) configured to receive the temperature signal (T_{SW}) and to generate, based on the temperature signal (T_{SW}), the control signal (S_{ON}) for the driver circuit (14).

2. The electronic circuit of claim 1,
wherein the control circuit is configured to output the control signal (S_{ON}) with a first level that causes the driver circuit to switch off the electronic switch (40) when the temperature signal (T_{SW}) exceeds a first threshold.

3. The electronic circuit of claim 2,
wherein the control circuit is configured to output the control signal (S_{ON}) with a second level that causes the driver circuit to switch on the electronic switch (40) when the temperature signal (T_{SW}) falls below a second threshold.

4. The electronic circuit of any of claim 2,
wherein the control circuit is configured to output the control signal (S_{ON}) with the first level that causes the driver circuit to switch off the electronic switch (40) when the temperature signal (T_{SW}) exceeds a third threshold and to keep the electronic switch in an off state (40) until a reset.

5. The electronic circuit of claim 2,
wherein the first threshold and the second threshold represent temperature differences between a junction temperature of an active area of the electronic switch (40) and a chip temperature remote from the active area.

6. The electronic circuit of claim 1,
wherein the estimator circuit includes a low-pass filter, wherein the temperature signal (T_{SW}) represents the low-pass filtered multiplier output signal (P_{SW}).

7. The electronic circuit of claim 1, wherein the estimator circuit emulates a thermal response of the electronic switch using the multiplier output signal (P_{SW}) as input.

8. The electronic circuit of claim 1,
wherein the estimator circuit is configured to receive one or more parameters (S_{CF}) representing at least one filter parameter, such as filter gain and filter time constant.

9. The electronic circuit of claim 1, wherein the electronic circuit further comprises:
an analog-to-digital converter circuit configured to convert the current sense signal (S_{CS}) and the voltage sense signal (S_{VS}) into a digital current sense signal (S_{CS}′) and a digital voltage sense signal (S_{VS}′), respectively,
wherein the multiplier is configured to multiply the digital current sense signal (S_{CS}′) and digital voltage sense signal (S_{VS}′).

10. The electronic circuit of claim 1,
wherein the control circuit comprises a first comparator configured to receive the temperature signal (T_{SW}).

11. The electronic circuit of claim 10,
wherein the first comparator has a hysteresis.

12. The electronic circuit of claim 1,
wherein the control circuit comprises a first comparator configured to receive the temperature signal (T_{SW}) and a reference signal (T_{REF}) representing a temperature threshold.

13. The electronic circuit of claim 12,
wherein the control circuit further comprises a-logic circuit configured to receive an output signal of the first comparator and an input signal (S_{IN}) of the electronic circuit, and
wherein the logic circuit outputs the control signal (S_{ON}) for the driver circuit.

14. The electronic circuit of claim 1,
wherein the electronic circuit further comprises a communication interface coupled to the control circuit, wherein the control circuit is configured to receive, via the communication interface, information from an external controller via the communication interface.

15. The electronic circuit of claim 14,
wherein the communication interface is coupled to the estimator circuit, wherein the estimator circuit is configured to receive, via the communication interface, information from the external controller via the communication interface.

16. The electronic circuit of claim 15,
wherein the information received by the estimator circuit from the communication interface is stored in a non-volatile memory.

17. The electronic circuit of claim 14,
wherein the communication interface is configured to receive data representing at least one filter parameter (S_{CF}) from the external controller.

18. The electronic circuit of claim 1, further comprising:
at least one first chip contact configured to receive the current sense signal (S_{CS}) and
at least one second chip contact configured to receive the voltage sense signal (S_{VS}).

19. A system comprising;
an electronic switch integrated in a first semiconductor die;
an electronic circuit integrated in a second semiconductor die, the electronic circuit comprising:
a driver circuit configured to provide a drive signal (S_{ON}′) to the electronic switch in accordance with a control signal (S_{ON});
a multiplier configured to receive, as input signals, a current sense signal (S_{CS}) representing a load current (i_{L}) passing through a load current path of the electronic switch and a voltage sense signal (S_{VS}) representing a voltage drop (V_{DS}) across the load current path;
an estimator circuit configured to receive a multiplier output signal (P_{SW}) from the multiplier and to generate, based on the multiplier output signal (P_{SW}), a temperature signal (T_{SW}) representing an estimated temperature of the electronic switch;
a control circuit configured to receive the temperature signal (T_{SW}) and to generate, based on the temperature signal (T_{SW}), the control signal (S_{ON}) for the driver circuit.

20. The system of claim 19,
wherein the first semiconductor die and the second semiconductor die are integrated in one chip package.
